(19) United States
(12) Patent Application Publication
(10) Pub. No.: US 2025/0232924 A1
(43) Pub. Date: Jul. 17, 2025

(54) ELECTROLYTIC CAPACITOR AND PRODUCTION METHOD THEREFOR

(71) Applicant: Panasonic Intellectual Property Management Co., Ltd., Osaka (JP)

(72) Inventors: YUKIHIRO SHIMASAKI, Hyogo (JP); JUNICHI KURITA, Osaka (JP); RIKAKO IWASAKI, Osaka (JP); SAORI UEDA, Osaka (JP)

(21) Appl. No.: 19/169,464

(22) Filed: Apr. 3, 2025

Related U.S. Application Data
(63) Continuation of application No. PCT/JP2023/038239, filed on Oct. 24, 2023.

(30) Foreign Application Priority Data
Oct. 26, 2022 (JP) 2022-171255

(51) Int. Cl. H01G 9/052; H01G 9/012; H01G 9/028; H01G 9/04; H01G 9/042; H01G 9/07; H01G 9/15

(52) U.S. Cl. CPC H01G 9/052; H01G 9/012; H01G 9/028; H01G 9/042; H01G 9/07; H01G 9/15; H01G 2009/05

(57) ABSTRACT

An electrolytic capacitor includes a capacitor element including an anode part and a cathode part, an exterior body sealing the capacitor element, a first external electrode electrically connected to the anode part and exposed from the exterior body, a second external electrode electrically connected to the cathode part and exposed from the exterior body, and a first base electrode connecting the anode part and the first external electrode. The first base electrode contains a first sintered metal, and the first sintered metal is in contact with an end surface of the anode part not covered with the exterior body and is in contact with the first external electrode. A relation 0.5≤W1/Tpc≤100 is satisfied, where Wp represents a width of the end surface of the anode part, and Tpc represents a thickness of the first sintered metal at a center of the width Wp.

### BACKGROUND

### 1. Technical Field

The present invention relates to an electrolytic capacitor and a production method for the electrolytic capacitor.

### 2. Description of the Related Art

An electrolytic capacitor includes a capacitor element including an anode part and a cathode part, an exterior body sealing the capacitor element, and an external electrode electrically connected to each of the anode part and the cathode part of the capacitor element.

International Publication WO2009/028183 proposes “a solid electrolytic capacitor including a first capacitor element including a first anode body made from valve metal, a first dielectric oxide film layer provided on a surface of the first anode body, a first solid electrolyte layer made of a conductive polymer provided on the first dielectric oxide film layer, and a first cathode layer provided on the first solid electrolyte layer, an exterior body made of insulating resin that covers the first capacitor element and has a first end surface where the first anode body is exposed, a first base electrode made of non-valve metal that is provided on the first end surface of the exterior body and is bonded to the first anode body, a first diffusion layer made of the valve metal of the first anode body and the non-valve metal of the first base electrode and connecting the first anode body and the first base electrode, a first external electrode provided on the first base electrode, and a second external electrode connected to the first cathode layer”.

The base electrode of the solid electrolytic capacitor of International Publication WO2009/028183 is “a metal layer formed by causing metal particles made from non-valve metal to collide with the first end surface of the exterior body at a speed more than or equal to 200 m/s and less than or equal to the speed of sound”.

International Publication WO2022/168769 proposes “an electrolytic capacitor including a resin molded body including a laminated body including a capacitor element and sealing resin that seals a periphery of the laminated body, and an anode external electrode and a cathode external electrode provided on an outer surface of the resin molded body, in which the capacitor element includes a valve metal substrate having a core portion and a porous portion formed along a surface of the core portion, and an end portion of the valve metal substrate being exposed to the outer surface of the resin molded body, a dielectric layer formed on the porous portion, a solid electrolyte layer formed on the dielectric layer, and a conductive layer formed on the solid electrolyte layer, the cathode external electrode is electrically connected to the conductive layer, the anode external electrode includes a first electrode layer that is in direct contact with the core portion and the porous portion of the valve metal substrate, in thickness in a normal direction of the outer surface of the first electrode layer, thickness at a portion formed in the core part of the valve metal substrate is larger than thickness at a portion formed in the porous portion of the valve metal substrate”.

The first electrode layer of International Publication WO2022/168769 is formed by an aerosol deposition method.

Unexamined Japanese Patent Publication No. 2020-141059 proposes “an electrolytic capacitor including a rectangular parallelepiped resin molded body including a laminated body including a capacitor element including an anode having a dielectric layer on a surface thereof and a cathode facing the anode, and sealing resin that seals a periphery of the laminated body, a first external electrode formed on a first end surface of the resin molded body and electrically connected to the anode exposed from the first end surface, a second external electrode formed on a second end surface of the resin molded body and electrically connected to the cathode exposed from the second end surface, a third external electrode formed on the first end surface side of a bottom surface of the resin molded body, and a fourth external electrode formed on the second end surface side of the bottom surface of the resin molded body, in which all of the first external electrode, the second external electrode, the third external electrode, and the fourth external electrode include a base electrode layer formed on the resin molded body and a plating layer formed on the base electrode layer, the base electrode layer of the first external electrode and the base electrode layer of the third external electrode are separated from each other, and the base electrode layer of the second external electrode and the base electrode layer of the fourth external electrode are separated from each other”.

### SUMMARY

One aspect of the present disclosure relates to an electrolytic capacitor. The electrolytic capacitor includes a capacitor element including an anode part and a cathode part, an exterior body that seals the capacitor element, a first external electrode electrically connected to the anode part and exposed from the exterior body, a second external electrode electrically connected to the cathode part and exposed from the exterior body, and a first base electrode that connects the anode part and the first external electrode. The first base electrode contains a first sintered metal. The first sintered metal is in contact with an end surface of the anode part, which is not covered with the exterior body, and is in contact with the first external electrode. A relation 0.5≤Wp/Tpc≤100 is satisfied, where Wp represents a width of the end surface of the anode part, and Tpc represents a thickness of the first sintered metal at a center of the width Wp.

Another aspect of the present disclosure relates to a production method for an electrolytic capacitor. The production method includes a step of preparing a capacitor element including an anode part and a cathode part, a step of sealing the capacitor element with an exterior body, a step of exposing an end surface of the anode part from the exterior body, a step of forming a first base electrode on the end surface of the anode part, and a step of forming a first external electrode electrically connected to the anode part via the first base electrode. The step of forming the first base electrode includes (i) a step of attaching a metal nanoink containing metal nanoparticles to the end surface of the anode part and a first surface of the exterior body facing the first external electrode, and (ii) a step of forming a first sintered metal by irradiating the metal nanoparticles with a light to sinter the metal nanoparticles after the step (i).

According to the present disclosure, it is possible to efficiently obtain an electrolytic capacitor having a base electrode containing a sintered metal at low cost.

Although novel features of the present disclosure are set forth in the appended claims, the present disclosure will be better understood by detailed description below with the drawings, taken in conjunction with other objects and features of the present disclosure, both as to construction and content.

### BRIEF DESCRIPTION OF THE DRAWINGS

FIG. 1 is a cross-sectional view schematically illustrating an electrolytic capacitor according to an exemplary embodiment of the present disclosure;

FIG. 2 is a cross-sectional view schematically illustrating a structure of an example of a capacitor element;

FIG. 3 is a schematic cross-sectional view illustrating a part of a structure of the electrolytic capacitor illustrated in FIG. 1 in an enlarged manner;

FIG. 4 is a schematic cross-sectional view illustrating another part of the structure of the electrolytic capacitor illustrated in FIG. 1 in an enlarged manner;

FIG. 5 is a cross-sectional view schematically illustrating the electrolytic capacitor according to another exemplary embodiment of the present disclosure;

FIG. 6 is a cross-sectional view schematically illustrating the electrolytic capacitor according to still another exemplary embodiment of the present disclosure;

FIG. 7 is a cross-sectional view schematically illustrating a structure of another example of the capacitor element;

FIG. 8 is a cross-sectional view schematically illustrating the electrolytic capacitor according to still another exemplary embodiment of the present disclosure;

FIG. 9 is a digital microscope image of a reference cross section on an anode side; and

FIG. 10 is a digital microscope image of a reference cross section on a cathode side.

### DETAILED DESCRIPTIONS OF EMBODIMENTS

Prior to description of an exemplary embodiment, a problem in the related art will be briefly described.

In the electrolytic capacitors described in International Publication WO2009/028183 and International Publication WO2022/168769, the yield of metal particles in a process of manufacturing the base electrode or the first electrode layer is low, and material loss easily occurs, and for this reason, manufacturing cost is hardly reduced.

The electrolytic capacitor described in Unexamined Japanese Patent Publication No. 2020-141059 takes long time for a manufacturing process and manufacturing cost is hardly reduced. Further, surface oxidation easily progresses in the base electrode of the plating layer. When the base electrode is oxidized, adhesion strength between the base electrode and the external electrode decreases, or ESR increases.

Hereinafter, an exemplary embodiment of the present disclosure will be described with reference to an example, but the present disclosure is not limited to an example to be described below. Although specific numerical values and materials are sometimes provided as examples in description below, other numerical values and materials may be used as long as the effect of the present disclosure can be achieved. In the present description, description “numerical value A to numerical value B” includes a numerical value A and a numerical value B, and can be read as “between numerical value A and numerical value B (inclusive)”. In description below, in a case where lower limits and upper limits of numerical values related to specific physical properties, conditions, or the like are illustrated, any of the illustrated lower limits and any of the illustrated upper limits can be optionally combined unless the lower limit is more than or equal to the upper limit. In a case where a plurality of materials are illustrated, one type of the materials may be selected and used alone, or two or more types of the materials may be used in combination.

Further, the present disclosure encompasses a combination of matters recited in two or more claims optionally selected from a plurality of claims recited in the appended claims. That is, as long as no technical contradiction arises, matters recited in two or more claims optionally selected from a plurality of claims recited in the appended claims can be combined.

An “electrolytic capacitor” may be read as a “solid electrolytic capacitor”.

### [Electrolytic Capacitor]

An electrolytic capacitor according to an exemplary embodiment of the present invention includes a capacitor element. The form of the capacitor element is not particularly limited. The capacitor element includes an anode part and a cathode part. The capacitor element includes, for example, an anode body, a dielectric layer, and a cathode layer. The anode part includes at least a part of the anode body. The cathode part includes a cathode layer.

The capacitor element is sealed with an exterior body. The exterior body is made from a sealing material. The sealing material may be, for example, a cured product of a thermosetting resin composition containing epoxy resin or the like.

Meanwhile, an end surface of the anode part has a portion not covered with the exterior body (exposed portion from the exterior body) in order to secure electrical connection. An end surface of the anode part is connected to a first base electrode. The first base electrode is connected to a first external electrode. The first base electrode contains first sintered metal. The first sintered metal is in contact with the end surface of the anode part that is not covered with the exterior body.

The first sintered metal desirably further covers a first surface of the exterior body facing the first external electrode. When the first sintered metal covers the first surface of the exterior body, a contact area between the first sintered metal and the first external electrode increases. Therefore, an electrolytic capacitor having lower resistance can be obtained.

An end surface of the cathode part may also have a portion not covered with the exterior body (an exposed portion from the exterior body). In this case, the end surface of the cathode part is connected to a second base electrode. The second base electrode is connected to a second external electrode. The second base electrode contains second sintered metal. The second sintered metal is in contact with the end surface of the cathode part that is not covered with the exterior body.

The second sintered metal desirably further covers a second surface of the exterior body facing the second external electrode. When the second sintered metal covers the second surface of the exterior body, a contact area between the second sintered metal and the second external electrode increases. Therefore, an electrolytic capacitor having lower resistance can be obtained.

The anode body has, for example, a first portion (also referred to as an “anode lead-out portion”) including a first end portion and a second portion (also referred to as a “cathode formation portion”) including a second end portion. The anode part includes the first portion (anode lead-out portion). The end surface of the anode part may be an end surface of a first end portion of the first portion.

The dielectric layer is formed at least on a surface of the second portion of the anode body. The cathode layer covers at least a part of the dielectric layer. The cathode part includes the cathode layer covering the second portion (cathode formation portion).

The cathode part may further include cathode foil (or a current collecting plate) protruding further to the second end portion than the cathode layer. The cathode foil is connected to the cathode layer. In this case, the end surface of the cathode part may be an end surface of a terminal end portion of the cathode foil. This makes it easy to form an end surface of the cathode part that is not covered with the exterior body. The cathode foil may be metal foil.

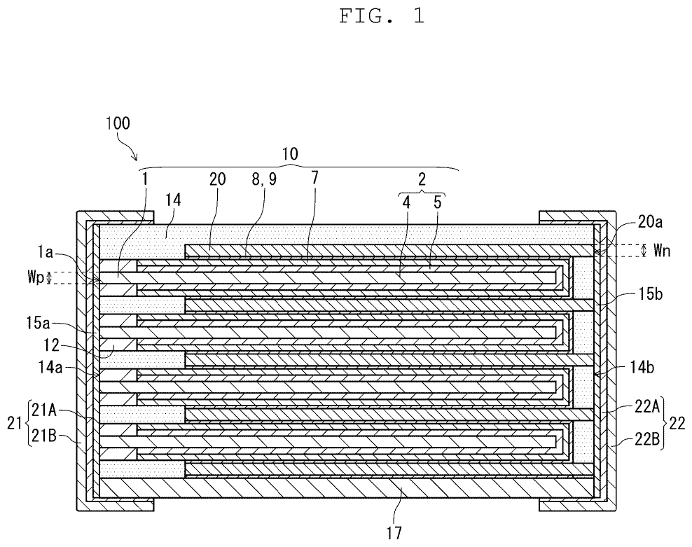

The first end portion and the second end portion of the anode body may correspond to, for example, one end portion and another end portion of the anode body when the anode body is viewed from a predetermined direction, respectively. The predetermined direction is a direction perpendicular to the accompanying FIGS. 1 to 6. Alternatively, the first end portion and the second end portion may correspond to two adjacent sides at an angle of, for example, 90 degrees when viewed in a vertical direction (longitudinal direction) of the accompanying drawings of FIGS. 1 to 6.

The anode body includes, for example, anode foil. The anode foil includes a metal core portion and a porous portion continuous with the metal core portion. In this case, an end surface of the anode part or an end surface of the first end portion of the first portion may include an end surface of the metal core portion and an end surface of the porous portion. The anode foil may be, for example, metal foil whose surface is roughened. The anode foil may be, for example, etching foil whose surface is roughened by etching. In this case, a plurality of the capacitor elements may be stacked to form a laminated body.

The anode body may include, for example, a sintered body of metal particles. In this case, the anode body has a metal wire (anode wire) partially embedded in the sintered body. The metal wire corresponds to the first portion. The sintered body corresponds to the second portion. An end surface of the anode part or an end surface of the first end portion of the first portion may include an end surface of a terminal end portion of the metal wire.

The sintered metal is formed by aggregation and sintering of metal nanoparticles. The sintered metal is structurally different from metal forming a plating layer. The metal nanoparticles are bonded to each other by metallic bonding. A neck may be formed between the metal nanoparticles. The sintered metal may be bonded to an end surface of the anode part or an end surface of the cathode part by metallic bonding. As a specific example, first sintered metal may be bonded to an end surface of the metal core portion or an end surface of a terminal end portion of the metal wire constituting the anode body by metallic bonding. Further, second sintered metal may be bonded to an end surface of a terminal end portion of the cathode foil of the cathode part by metallic bonding. By this, bonding force between an end surface of the anode part and the first base electrode or bonding force between an end surface of the cathode part and the second base electrode can be increased, and peeling hardly occurs.

The sintered metal is thin, and may be bonded to an end surface of the anode part or an end surface of the cathode part by metallic bonding in a wide area. For the above reason, a material loss in a manufacturing process hardly occurs, and manufacturing cost may be easily reduced. A process of forming the sintered metal is, for example, photo firing (photo sintering). Therefore, time required for the process is significantly short as compared with that for formation of a plating layer. Further, in the base electrode of the plating layer, surface oxidation easily progresses, and ESR easily increases. On the other hand, in the sintered metal, surface oxidation is easily controlled. Therefore, the base electrode can be efficiently formed at low cost by using the sintered metal.

The first sintered metal is thin, and may be metallic-bonded to an end surface of the anode part in a wide area. Specifically, when width of an end surface of the anode part is Wp and thickness of the first sintered metal at the center of width Wp is Tpc, the ratio Wp/Tpc satisfies 0.5≤Wp/Tpc≤100. Width Wp only needs to be width of the electrolytic capacitor in a cross section (hereinafter, also referred to as “reference cross section”) parallel to a thickness direction of the anode body and a direction from the first end portion toward the second end portion. The reference cross section is a direction parallel to the accompanying FIGS. 1 to 6. Width Wp corresponds to thickness of the anode foil in a case where the anode body includes the anode foil. When the anode body has a metal wire (anode wire) partially embedded in the sintered body, width Wp corresponds to a diameter of the metal wire.

The ratio Wp/Tpc may satisfy 1≤Wp/Tpc, may satisfy 1.5≤Wp/Tpc, may satisfy 2≤Wp/Tpc, may satisfy 3≤Wp/Tpc, may satisfy 5≤Wp/Tpc, or may satisfy 10≤Wp/Tpc. The ratio Wp/Tpc may satisfy Wp/Tpc≤90, may satisfy Wp/Tpc≤85, may satisfy Wp/Tpc≤80, may satisfy Wp/Tpc≤75, or may satisfy Wp/Tpc≤70. The ratio Wp/Tpc may satisfy 1.5≤Wp/Tpc≤100, or may satisfy 2≤Wp/Tpc≤100.

The second sintered metal is thin and may be metallic-bonded to an end surface of the cathode part in a wide area. Specifically, when width of an end surface of the cathode part is Wn and thickness of the second sintered metal at the center of width Wn is Tnc, the ratio Wn/Tnc satisfies 0.5≤Wn/Tnc≤100. Width Wn is width in the reference cross section. Width Wn corresponds to thickness of the cathode foil in a case where the cathode body includes the cathode foil.

The ratio Wn/Tnc may satisfy 1≤Wn/Tnc, may satisfy 1.5≤Wn/Tnc, may satisfy 2≤Wn/Tnc, may satisfy 3≤Wn/Tnc, may satisfy 5≤Wn/Tnc, or may satisfy 10≤Wn/Tnc. The ratio Wn/Tnc may satisfy Wn/Tnc≤90, may satisfy Wn/Tnc≤85, may satisfy Wn/Tnc≤80, may satisfy Wn/Tnc≤75, or may satisfy Wn/Tnc≤70. The ratio Wn/Tnc may satisfy 1.5≤Wn/Tnc≤100, or may satisfy 2≤Wn/Tnc≤100.

A shape in the reference cross section of the first sintered metal may be a flat shape. When thickness of the first sintered metal at the center of width Wp is Tpc and thickness of the first sintered metal at a position away from the center of width Wp by Wp/3 is Tpt, a ratio Tpc/Tpt is, for example, more than or equal to 0.5 (0.5≤Tpc/Tpt), and may be preferably less than or equal to 2 or may be less than or equal to 1.5.

Similarly, a shape in the reference cross section of the second sintered metal may be a flat shape. When thickness of the second sintered metal at the center of width Wn is Tnc and thickness of the second sintered metal at a position away from the center of width Wn by Wn/3 is Tnt, the ratio Tnc/Tnt is, for example, more than or equal to 0.5 (0.5≤Tnc/Tnt), and may be preferably less than or equal to 2, or may be less than or equal to 1.5.

In a case where the first sintered metal has a flat shape, a contact area Spo between the first sintered metal and the first external electrode is more than or equal to a contact area Spi between the first sintered metal and an end surface of the anode part. That is, the ratio Spo/Spi is, for example, more than or equal to 1.0 (1.0≤Spo/Spi). In a case where the first sintered metal covers up to a surface (first surface) of the exterior body, the ratio Spo/Spi can be more than or equal to 3. On the other hand, in a case where the first sintered metal hardly covers a surface (first surface) of the exterior body, the ratio Spo/Spi may be less than or equal to 1.5, and further less than or equal to 1.2.

Similarly, in a case where the second sintered metal has a flat shape, a contact area Sno between the second sintered metal and the second external electrode is more than or equal to a contact area Sni between the second sintered metal and an end surface of the cathode part. That is, the ratio Sno/Sni is, for example, more than or equal to 1.0 (1.0≤Sno/Sni). In a case where the second sintered metal covers up to a surface (second surface) of the exterior body, the ratio Sno/Sni may be more than or equal to 3. On the other hand, in a case where the second sintered metal hardly covers a surface (second surface) of the exterior body, the ratio Sno/Sni may be less than or equal to 1.5, and further less than or equal to 1.2.

As described above, the first sintered metal and the second sintered metal can be formed to be thin. Therefore, it is possible to suppress decrease in productivity accompanying increase in thickness of the sintered metal.

The first sintered metal and the second sintered metal may contain a phosphorus element. The first sintered metal and the second sintered metal may have the same configuration or different configurations. Since the sintered metal layer containing a phosphorus element has high corrosion resistance, it is suitable as a base electrode. By forming the base electrode having high corrosion resistance, peeling or the like between the base electrode and the external electrode is suppressed, and deterioration of the cathode part due to moisture or oxygen is suppressed.

The first sintered metal and the second sintered metal can be formed by a step of attaching metal nanoink containing a phosphorus element and metal nanoparticles to an end surface of the anode part or the cathode part, and a step of irradiating metal nanoparticles on the end surface with light to sinter the metal nanoparticles. Such a process is simple and can be completed in short time. Further, a utilization rate of metal nanoparticles is high, and material cost is easily reduced. That is, the base electrode containing the sintered metal can be efficiently formed at low cost.

In the first sintered metal and the second sintered metal, desirably, an amount of the phosphorus element distributed at a side close to the external electrode is greater than an amount of the phosphorus element distributed at a side close to the end surface of the anode part or the cathode part. According to such distribution, even if the base electrode and the external electrode partially peel off, the base electrode having high corrosion resistance serves as a barrier. Therefore, deterioration of the cathode part due to moisture and oxygen is suppressed. For example, at a center line of a cross section of the sintered metal, the sintered metal is divided into two regions, which are a first region located at a side close to the end surface of the anode part or the cathode part and a second region located at a side close to the external electrode. In this case, an amount of the phosphorus element distributed in the second region located at a side close to the external electrode only needs to be large. In other words, the sintered metal may have a normal layer containing none or only a small amount of the phosphorus element and a phosphorus-rich layer containing a larger amount of the phosphorus element. Even in a case where a layer structure is not clearly formed, a normal region containing none or only a small amount of the phosphorus element and a phosphorus-rich region containing a larger amount of the phosphorus element may be formed. Further, from a more microscopic viewpoint, the phosphorus element is distributed also in the metal particles constituting the sintered metal. Phosphorus element concentration may be high in an outer region of the metal particles, concentration of the phosphorus element may be low or the phosphorus element may not be present in an inner region of the metal particles.

A content ratio Poe of the phosphorus element in the second region located at a side close to the external electrode may be more than or equal to twice a content ratio Pts of the phosphorus element in the first region located at a side close to the end surface. The content ratios Poe and Pts are measured in ten measurement regions of 10,000 nm² (for example, a square region of 100 nm on one side) including the center in a thickness direction of each of the second region located at a side close to the external electrode and the first region located at a side close to the end surface. For example, an amount of the phosphorus element present in each measurement region is preferably measured by SEM-EDX, and Poe/Pts is preferably determined as a ratio of an average value of the measured amounts. A composition ratio of the element in each measurement region may be obtained by another method such as a method using an electron probe microanalyzer (EPMA).

Depth (Dp) from the external electrode (toward the end surface of the anode part or the cathode part) at which the count number of the phosphorus element (phosphorus element concentration or detection intensity of the phosphorus element) measured by SEM-EDX, EPMA, or the like becomes less than or equal to 10% of a maximum value is, for example, 10% to 80% of thickness (Tpc, Tnc) of the first and second sintered metal, and may be 10% to 30%. In this case, corrosion resistance of the base electrode is remarkably enhanced. Partial peeling between the base electrode and the external electrode, and deterioration of the cathode part due to moisture and oxygen are also remarkably suppressed.

Predetermined thickness and the depth Dp of the first and second sintered metal may be measured at any ten or more points in a cross-sectional image of a laminated portion of an end surface of the anode part or the cathode part and the base electrode, and may be calculated as an average value of the measured values.

The first external electrode and/or the second external electrode may be formed by various methods. For example, the external electrode may be formed by a film forming technique such as an electrolytic plating method, electroless plating, a sputtering method, a vacuum vapor deposition method, a chemical vapor deposition (CVD) method, a cold spraying method, or a thermal spraying method.

The first or second external electrode may have a plating layer covering at least a part of the first or second sintered metal. The plating layer contains, for example, nickel (Ni), copper (Cu), zinc (Zn), tin (Sn), silver (Ag), gold (Au), and the like. The plating layer typically includes a Ni plating layer. The plating layer may further include a Sn plating layer covering at least a part of the Ni plating layer. The plating layer having such a multilayer structure has high conductivity and improves connectivity between the external electrode and various terminal electrodes.

The first or second external electrode including the plating layer may further include a conductive layer interposed between the first or second sintered metal and the plating layer. The conductive layer is not particularly limited, but may be composed of conductive particles and resin. The conductive layer may be, for example, a cured product (conductive paste layer) of conductive paste containing conductive particles and resin. For the conductive particles, for example, metal particles of silver, copper, and the like, and carbon particles may be used. The resin desirably contains epoxy resin. That is, the conductive paste may be a thermosetting resin composition containing conductive particles and epoxy resin. The conductive paste layer can be formed by applying conductive paste so as to cover a sintered metal layer and drying the conductive paste. The conductive layer may cover a part of a surface (for example, a top or bottom surface) intersecting a principal surface of the exterior body where an end surface of the anode part or the cathode part of the capacitor element is exposed.

The first or second external electrode may have a lead frame that covers at least a part of the first or second sintered metal. The lead frame may be formed by, for example, blanking and bending of metal foil. At this time, the first or second external electrode may further have a solder layer interposed between the first or second sintered metal and the lead frame, or may have the above-described conductive layer (conductive paste layer or the like). An outer surface of the first and second external electrodes is desirably made from metal having excellent wettability with solder. Examples of such metal include Sn, Au, Ag, Pd, and the like.

Preferred examples of a combination of an end surface of the anode part or the cathode part, the base electrode, and the external electrode will be described below.
(1) end surface/sintered metal/first plating layer (for example, Ni plating layer)/second plating layer (for example, Sn plating layer)
(2) end surface/sintered metal (having laminated structure of normal layer and phosphorus-rich layer)/first plating layer (for example, Ni plating layer)/second plating layer (for example, Sn plating layer)
(3) end surface/sintered metal/conductive layer/first plating layer (for example, Ni plating layer)/second plating layer (for example, Sn plating layer)
(4) end surface/sintered metal (having laminated structure of normal layer and phosphorus-rich layer)/conductive layer/first plating layer (for example, Ni plating layer)/second plating layer (for example, Sn plating layer)
(5) end surface/sintered metal/conductive layer/lead frame
(6) end surface/sintered metal/solder layer/lead frame
(7) end surface/sintered metal (having laminated structure of normal layer and phosphorus-rich layer)/conductive layer/lead frame
(8) end surface/sintered metal (having laminated structure of normal layer and phosphorus-rich layer)/solder layer/lead frame

In a Ni/Sn plating layer including two layers, a Ni plating layer and a Sn plating layer formed on a surface of the Ni plating layer, Ni of the Ni plating layer may be diffused to the Sn plating side, and Sn of the Sn plating layer may be diffused to the Ni plating layer side to form an alloy layer of Ni and Sn.

The electrolytic capacitor may have an element laminated body including a plurality of the capacitor elements. In this case, end surfaces of a plurality of the anode parts may be exposed from the exterior body. Then, at least a part of the end surfaces of the anode parts and the first external electrode may be electrically connected via a first sintered metal layer. Further, end surfaces of a plurality of the cathode parts may be exposed from the exterior body. Then, at least a part of the end surfaces of the cathode parts and the second external electrode may be electrically connected via the second sintered metal layer.

A plurality of the capacitor elements may face the same direction or may face different directions. For example, the anode part and the cathode part may be alternately laminated so as to face in opposite directions. For example, the anode part and the cathode part may be laminated in optional order so as to face in opposite directions. For example, the anode part and the cathode part may be alternately laminated so as to intersect at 90 degrees. For example, the anode part and the cathode part may be laminated so as to intersect at 90 degrees in optional order.

Only an end surface of the anode part may be exposed from the exterior body, and the end surface may be electrically connected to the first external electrode via the first sintered metal layer. Both an end surface of the anode part and an end surface of the cathode part may also be exposed from the exterior body, and each of the end surfaces may be electrically connected to the first external electrode and the second external electrode via the first and second sintered metal layers.

End surfaces of a plurality of the anode parts may be exposed from the first principal surface of the exterior body. In this case, the first external electrode may be disposed so as to cover the first principal surface. At this time, end surfaces of a plurality of the cathode parts may be exposed from the second principal surface (for example, on the opposite side of the first principal surface) different from the first principal surface of the exterior body. In this case, the first principal surface corresponds to the first surface, and the second principal surface corresponds to the second surface.

A part of end surfaces of a plurality of the anode parts may be exposed from the first principal surface of the exterior body, and other end surfaces of the anode parts may be exposed from the second principal surface (for example, on the opposite side of the first principal surface) different from the first principal surface of the exterior body. In this case, two of the first external electrodes are provided. One of the first external electrodes is disposed so as to cover the first principal surface, and the other first external electrode is disposed so as to cover the second principal surface. At this time, end surfaces of a plurality of the cathode parts may be exposed from a third principal surface different from the first principal surface and the second principal surface of the exterior body. In this case, the second external electrode may be disposed so as to cover the third principal surface. A part of end surfaces of a plurality of the cathode parts may be exposed from the third principal surface of the exterior body, and other end surfaces of the cathode parts may be exposed from a fourth principal surface (for example, on the opposite side of the third principal surface) different from the first to third principal surfaces of the exterior body. In this case, two of the second external electrodes are provided. One of the second external electrode is disposed so as to cover the third principal surface, and the other second external electrode is disposed so as to cover the fourth principal surface. Note that the first principal surface and the second principal surface correspond to the first surface, and the third principal surface and the fourth principal surface correspond to the second surface.

Next, a production method for the electrolytic capacitor will be exemplarily described, but the production method for the electrolytic capacitor according to the present disclosure is not limited to one described below.

A production method for the electrolytic capacitor includes, for example, a step of preparing the capacitor element including the anode part and the cathode part, a step of sealing the capacitor element with the exterior body, a step of exposing an end surface of the anode part from the exterior body, a step of forming the first base electrode on an end surface of the anode part, and a step of forming the first external electrode electrically connected to the anode part via the first base electrode.

The production method may further include a step of exposing an end surface of the cathode part from the exterior body, a step of forming the second base electrode on an end surface of the cathode part, and a step of forming the second external electrode electrically connected to the cathode part via the second base electrode. Hereinafter, each step will be further described.

### (Step of Preparing Capacitor Element)

The step of preparing the capacitor element includes a step of preparing the anode body. The step of preparing the capacitor element may include a step of disposing a separation layer (insulating member) on a part of the anode body. The step of preparing the capacitor element may include a step of laminating a plurality of the capacitor elements to obtain an element laminated body.

### (Anode Body)

In the step of preparing the anode body, the anode body including the first portion including the first end portion and the second portion including the second end portion is prepared. The anode part includes the first portion (anode lead-out portion) of the anode body. The first portion of the anode body may include a scheduled removal end portion to be removed later by cutting or the like. At least the second portion of the anode body has a porous portion. A dielectric layer is later formed on a surface of at least the second portion.

The anode body contains valve metal, an alloy containing valve metal, a compound containing valve metal (such as an intermetallic compound), and the like. These materials can be used alone, or two or more of these materials may be used in combination. As the valve metal, aluminum, tantalum, niobium, titanium, and the like can be used. The anode body may be foil (anode foil) of valve metal, an alloy containing valve metal, or a compound containing valve metal, or may be a porous sintered body of valve metal, an alloy containing valve metal, or a compound containing valve metal.

When a foil (anode foil) is used for the anode body, a porous portion is formed on a surface layer portion of at least the second portion of the anode foil. That is, the second portion includes a metal core portion and a porous portion formed on a surface of the metal core portion. The porous portion may be formed by roughening a surface of at least the second portion of the anode foil by etching or the like. Roughening treatment such as etching treatment can be performed after a predetermined masking member is arranged on a surface of the first portion. On the other hand, it is also possible to perform roughening treatment on an entire surface of the anode foil by etching treatment. In the former case, the anode foil having no porous portion on a surface of the first portion and having a porous portion on a surface of the second portion is obtained. In the latter case, the porous portion is formed not only on a surface of the second portion but also on a surface of the first portion.

As the etching treatment, a publicly-known method only needs to be used, and, for example, electrolytic etching is used. The masking member is not limited to any particular member, but an insulator such as resin is preferable. The masking member may be a conductor containing a conductive material.

When the entire surface of the anode foil is subjected to roughening treatment, a porous portion is also present on a surface of the first portion. The porous portion of the first portion may be compressed in advance so that a pore is closed. This makes it possible to suppress entry of air and moisture into the inside of the electrolytic capacitor through the porous portion from an end surface of the anode part exposed from the exterior body.

In a case where a sintered body is used for the anode body, powder containing valve metal (for example, powder of valve metal, powder of an alloy or a compound containing valve metal) is molded and sintered to obtain the sintered body. For example, together with powder of valve metal, a buried portion of an anode wire to be connected to the anode body is put into a mold in a manner embedded in the powder, and compression-molding is performed. After the above, the molded body is sintered to form a porous anode body in which a part of the anode wire is implanted. The sintering is preferably performed under reduced pressure.

### (Separation Layer)

In a case where foil (anode foil) is used for the anode body, an insulating separation layer for electrically separating the first portion and the second portion may be provided. In this step, an insulating member is disposed on the first portion of the anode body with a dielectric layer interposed between them. The insulating member is disposed so as to separate the first portion from the cathode part formed in a subsequent step. The separation layer may be provided close to the cathode part in a manner covering at least a part of a surface of the first portion.

The separation layer is obtained, for example, by bonding a sheet-like insulating member (resin tape or the like) to the first portion. In a case where anode foil having a porous portion on a surface is used, the porous portion of the first portion may be compressed and flattened. Then, the insulating member may be brought into close contact with the flattened first portion. The sheet-like insulating member preferably has an adhesion layer on a surface on the side to be attached to the first portion.

The insulating member in close contact with the first portion may be formed by applying liquid resin to the first portion, or impregnating the first portion with liquid resin. In the method using the liquid resin, the insulating member is formed to fill irregularities on a surface of a porous portion of the first portion. The liquid resin easily enters a recess on a surface of the porous portion. Therefore, the insulating member can be easily formed also in a recess.

### (Dielectric Layer)

The dielectric layer is formed by anodizing valve metal of a surface of at least the second portion of the anode body by anodizing treatment or the like. In the anodizing treatment, for example, a surface of the anode body is impregnated with anodizing solution by immersing the anode body in the anodizing solution. Then, the anodization can be performed by applying voltage between the anode body as an anode and a cathode immersed in the anodizing solution. In a case where a porous portion is provided on a front surface of the anode body, the dielectric layer is formed along an uneven shape of a surface of the porous portion. The dielectric layer contains an oxide of valve metal. For example, in a case where aluminum is used as the valve metal, the dielectric layer contains an aluminum oxide. In a case where tantalum is used as the valve metal, the dielectric layer contains a tantalum oxide. The dielectric layer is formed at least along a surface of the second portion where the porous portion is formed (including an inner wall surface of a pore of the porous portion). Note that the method of forming the dielectric layer is not limited to this. An insulating layer functioning as a dielectric material only needs to be formed on a surface of the second portion. The dielectric layer may also be formed on a front surface of the first portion (for example, on a porous portion of the surface of the first portion).

### (Cathode Part)

The cathode part includes a solid electrolyte layer that covers at least a part of the dielectric layer and a cathode lead-out layer that covers at least a part of the solid electrolyte layer. The cathode part may include cathode foil. The cathode foil is electrically connected to the cathode lead-out layer and is electrically connected to the second external electrode.

### (Solid Electrolyte Layer)

The solid electrolyte layer contains a conductive polymer, for example. As the conductive polymer, for example, polypyrrole, polythiophene, polyaniline, derivatives of these, and the like can be used. For example, the solid electrolyte layer can be formed by chemical polymerization and/or electrolytic polymerization of a raw material monomer on the dielectric layer. Alternatively, the solid electrolyte layer can be formed by applying solution in which the conductive polymer is dissolved or dispersion in which the conductive polymer is dispersed to the dielectric layer. The solid electrolyte layer may contain a manganese compound.

### (Cathode Lead-Out Layer)

The cathode lead-out layer includes, for example, a carbon layer and a conductive paste layer. The carbon layer only needs to have conductivity, and can be constituted, for example, by using a conductive carbon material, such as graphite. The carbon layer is formed, for example, by applying carbon paste to at least a part of a surface of the solid electrolyte layer. The conductive paste layer may be a cured product (metal paste layer) of metal paste containing metal particles and resin. The metal particles may be particles of silver, copper, nickel, or the like. In particular, silver is desirable. That is, the metal paste layer is preferably a silver-paste layer. The resin desirably contains epoxy resin. The metal paste may be a thermosetting resin composition containing metal particles and epoxy resin. The metal paste layer is formed, for example, by being applied to a surface of a carbon layer. Note that the configuration of the cathode lead-out layer is not limited to this, and only needs to be a configuration having a current collector function.

### (Cathode Foil)

The cathode foil is, for example, metal foil. The metal foil may be sintered foil, vapor deposited foil, or coated foil. The cathode foil may be sintered foil, vapor deposited foil, or coated foil obtained by covering a surface of metal foil (for example, Al foil or Cu foil) with a conductive film by vapor deposition or coating. The vapor deposited foil may be Al foil with Ni vapor-deposited on a surface. Examples of the conductive film include Ti, TiC, TiO, and carbon (C) films, and the like. The conductive film may be a carbon coating film.

(Step of Sealing Capacitor Element with Exterior Body)

First, a mold configured such that an end surface of the anode part and an end surface of the cathode part are exposed and a remaining part of the capacitor element is sealed may be used. The capacitor element may be disposed in a mold, and then the capacitor element may be sealed with a sealing material to form the exterior body. Second, a mold configured such that an end surface of the anode part and an end surface of the cathode part are not exposed and the entire capacitor element is sealed may be used. The capacitor element may be disposed in a mold, and then the capacitor element may be sealed with a sealing material to form the exterior body. In either case, it is efficient to first form an aggregate of a plurality of the capacitor elements. Then, it is efficient to seal the aggregate with a sealing material to form the exterior body. Such a process can be performed by a transfer molding method, a compression molding method, or the like. In a case of a first method, a step of exposing an end surface of the anode part and an end surface of the cathode part from the exterior body is also simultaneously performed.

The sealing material preferably contains, for example, a thermosetting resin composition, and may contain thermoplastic resin. In the transfer molding method or the compression molding method, an uncured sealing material is cured to form the exterior body. The thermosetting resin composition may contain a filler, a curing agent, a polymerization initiator, a catalyst, and the like in addition to base resin such as epoxy resin.

(Step of Exposing End Surface of Anode Part or Cathode Part from Exterior Body)

In a case where an end surface of the anode part is exposed from the exterior body, for example, a part of the exterior body may be removed. Specifically, a method of covering the capacitor element with the exterior body and then polishing the exterior body so that an end surface of the anode part is exposed from the exterior body, and a method of separating a part of the exterior body can be used. A part of the first portion may be separated together with a part of the exterior body. In this case, an end surface of the first end portion of the anode body having a surface on which a natural oxide film is not formed can be easily exposed from the exterior body. Therefore, a highly reliable connection state with low resistance can be obtained between the first portion, the first base electrode, and the first external electrode.

In a case where an element laminated body includes the cathode foil, the exterior body may be partially removed to expose an end portion of the cathode foil from the exterior body. As a method of exposing an end portion of the cathode foil from the exterior body, a method similar to the method of exposing an end surface of the first end portion of the anode body from the exterior body can be used. A part of the cathode foil may be separated together with a part of the exterior body. An exposed surface of an end portion of the cathode foil from the exterior body is preferably a surface different from a surface of the exterior body from which an end surface of the first end portion of the anode body is exposed.

The anode body and the insulating member of the element laminated body may be partially removed together with the exterior body to expose an end surface of the first end portion and an end surface of the insulating member from the exterior body. In this case, flush end surfaces exposed from the exterior body are formed on the anode body and the insulating member. By this, an end surface of the anode body and an end surface of the insulating member, which are flush with a surface of the exterior body, can be easily exposed from the exterior body.

As described above, an end surface of the anode body (first end portion) on which a natural oxide film is not formed and an end surface of the cathode foil can be easily exposed from the exterior body by cutting or the like. Therefore, a highly reliable connection state with low resistance can be obtained between the anode body or the first portion and the first external electrode.

An aggregate of a plurality of the capacitor elements may be formed, and the aggregate may be sealed with a sealing material to form the exterior body. In the above case, when the assembly is divided into individual pieces, a connecting portion connecting the adjacent anode parts in the assembly and a connecting portion connecting the adjacent cathode parts in the assembly may be cut. In this case, an end surface of the anode part and an end surface of the cathode part are exposed on a cutting surface. Such a cutting surface may be a surface subjected to etching processing by plasma or the like.

### (Step of Forming Base Metal)

The step of forming the first base electrode includes, for example, (i) a step of attaching metal nanoink containing metal nanoparticles to an end surface of the anode part and the first surface of the exterior body, which faces the first external electrode (application step), and then (ii) a step of forming a first sintered metal by irradiating the metal nanoparticles with light to sinter (or photo-fire) the metal nanoparticles (photo-sintering step).

Similarly, the step of forming the second base electrode includes, for example, (i) a step of attaching metal nanoink containing metal nanoparticles to an end surface of the cathode part and the second surface of the exterior body facing the second external electrode (application step), and then (ii) a step of forming a second sintered metal by irradiating the metal nanoparticles with light to sinter (or photo-fire) the metal nanoparticles.

Here, an end surface of the anode part or the cathode part and the first or second surface of the exterior body may have different sintering conditions for the metal nanoparticles. An end surface of the anode part or the cathode part is a metal surface, and has high thermal diffusibility. For this reason, the metal nanoparticles on an end surface of the anode part or the cathode part are less likely to be sintered than the metal nanoparticles on the first or second surface of the exterior body. When photo firing is performed under the condition that the metal nanoparticles on an end surface of the anode part or the cathode part are sintered, the metal nanoparticles on a surface of the exterior body are burned off, and the sintered metal may not remain. On the other hand, even when photo firing is performed under the condition that the metal nanoparticles on a surface of the exterior body are sintered, the metal nanoparticles on an end surface of the anode part or the cathode part may not be sintered. In order to more reliably sinter both the metal nanoparticles on an end surface of the anode part or the cathode part and on the first or second surface of the exterior body, it is desirable to perform photo firing in two or more stages.

Specifically, the step of forming the first sintered metal may include a step of forming a part of the first sintered metal by irradiating the applied metal nanoparticles with first light to sinter the metal nanoparticles located on the first surface of the exterior body, and a step of forming a remaining part of the first sintered metal by irradiating the metal nanoparticles located on an end surface of the anode part with second light having higher energy than the first light to sinter the metal nanoparticles located on the end surface of the anode part.

Similarly, the step of forming the second sintered metal may include a step of forming a part of the second sintered metal by irradiating the applied metal nanoparticles located on the second surface of the exterior body with the first light to sinter the metal nanoparticles located on the second surface of the exterior body, and a step of forming a remaining part of the second sintered metal by irradiating the metal nanoparticles located on an end surface of the cathode part with the second light having higher energy than the first light to sinter the metal nanoparticles on the second end surface of the cathode part.

First, when the metal nanoparticles on a surface of the exterior body are sintered with low energy, sintered metal having metallic luster is formed on the surface of the exterior body. After the above, even when the metal nanoparticles on an end surface of the anode part or the cathode part are irradiated with high energy light, the sintered metal having metallic luster hardly absorbs thermal energy, and therefore remains without being burned off. On the other hand, the metal nanoparticles on the end surface of the anode part or the cathode part are also subjected to photo firing to form sintered metal having metallic luster.

As the metal nanoparticles, nanoparticles of copper (Cu), silver (Ag), or the like can be used. The nanoparticles may be generally spherical particles or fibrous nanowires. Average particle size of the nanoparticles only needs to be less than 1000 nm, and may be, for example, may range from 30 nm to 100 nm, inclusive. Average particle size of the nanoparticles is D50 particle size (median diameter) in volume-based particle size distribution measured using a dynamic light scattering type particle size distribution measuring apparatus.

The metal nanoink may include a phosphoric ester. The phosphoric ester may act as a dispersant for stably dispersing metal nanoparticles in a dispersion medium. The phosphoric ester may be a phosphorous acid ester, a phosphonic acid ester, or the like. An organic group that forms an ester bond is not particularly limited. A ratio of mass of the phosphorus (P) element to mass of metal nanoparticles contained in the metal nanoink may range, for example, from 2% to 8%, inclusive. As a result, the sintered metal may contain the phosphorus (P) element in a proportion ranging, for example, from 1% by mass to 3% by mass, inclusive.

The metal nanoink desirably further contains a reducing agent. The reducing agent is useful for forming sintered metal having low resistance in order to reduce a natural oxide film on an end surface of the anode part or the cathode part or prevent oxidation of metal nanoparticles. The reducing agent also contributes to energy saving of irradiation light required for photo firing. The reducing agent may contain an organic acid. The organic acid can reduce energy required for sintering metal nanoparticles by about 30%.

The organic acid has a low environmental load and high volatility. Therefore, the organic acid hardly remains in sintered metal and is useful for forming sintered metal that has low resistance. A ratio of mass of the reducing agent to mass of metal nanoparticles contained in the metal nanoink may range, for example, from 5% to 20%, inclusive.

Among the organic acids, an organic acid having a melting point in a range from 95° C. to 160° C., inclusive, is effective. Specifically, the organic acid may be appropriately selected from organic acids used for solder flux. Among them, it is desirable to use at least one of adipic acid and abietic acid in terms of cost, reducing power, and the like.

As a dispersion medium of the metal nanoink, water or an organic solvent may be used. As the organic solvent, a class 2 organic solvent can be used. Examples of the class 2 organic solvent include acetone, butyl alcohol propyl alcohol, pentyl alcohol, ethyl ether, ethylene glycol monoethyl ether, ethylene glycol monoethyl ether acetate, ethylene glycol mono-normal butyl ether, ethylene glycol monomethyl ether, isobutyl acetate, isopropyl acetate, isopentyl acetate, ethyl acetate, normal butyl acetate, normal propyl acetate, normal pentyl acetate, methyl acetate, cyclohexanol, cyclohexanone, 1,4-dioxane, N,N-dimethylformamide, tetrahydrofuran, normal hexane, and methyl ethyl ketone.

In the application step, the metal nanoink is applied to an end surface of the anode part or the cathode part by using an applicator. The applicator may be, for example, an applicator of an inkjet type. In the case of the inkjet type, since the metal nanoink can be selectively applied to a necessary portion at high speed, material loss is very small.

After the above, a volatile component (dispersion medium) contained in the metal nanoink is dried. A drying step is, for example, five minutes or less, and in a temperature environment of less than or equal to 100° C., usually about several seconds are sufficient.

In the photo-sintering step, for example, the metal nanoparticles are irradiated with pulse light of 0.1 ms to 10 ms. A light source of the pulse light is not particularly limited, but a xenon light source, a YAG laser, or the like may be used. Environmental temperature of photo firing only needs to be, for example, less than or equal to 50° C. or room temperature. The photo firing may be performed under atmospheric pressure, or may be performed in an inert gas atmosphere such as nitrogen gas. Such a process is completed in a very short time. Therefore, manufacturing cost is easily reduced.

In photo firing, sintered metal is instantaneously formed. At that time, since metal nanoparticles aggregate, a large amount of the phosphorus element-containing component added as a dispersant remains in a void between the particles. The phosphorus element tends to volatilize during drying or photo firing. For this reason, the phosphorus element tends to be unevenly distributed on the surface layer side on the opposite side to an end surface of the anode part or the cathode part. That is, a laminated structure of a normal layer containing a small amount of the phosphorus element and a phosphorus-rich layer containing a larger amount of the phosphorus element may be formed as the sintered metal.

The step of forming the first base electrode and the step of forming the second base electrode may be performed by different processes, but it is efficient to similarly perform these steps by the above process.

After the above, the step of forming the first external electrode connected to the first base electrode and the step of forming the second external electrode connected to the second base electrode are performed by a desired method.

The external electrode can be easily formed of a plating layer. The plating layer may have a single layer structure or a multilayer structure. For example, a Ni plating layer and a Sn plating layer are sequentially formed. The plating layer may be formed so as to cover at least a part of the sintered metal.

In order to form the plating layer having sufficient thickness, a conductive layer or a conductive paste layer may be formed before forming the plating layer. The conductive layer may be formed, for example, by applying conductive paste to a surface of the base electrode and then curing the conductive paste. As the conductive paste, a thermosetting resin composition containing metal particles and epoxy resin may be used. After the above, the plating layer only needs to be formed so as to cover at least a part of the conductive layer by a method such as a barrel plating method. The plating layer includes a Ni plating layer, and may further include a Sn plating layer covering at least a part of such a Ni plating layer.

The external electrode may be formed by a lead frame covering at least a part of the sintered metal. In order to form strong electrical connection between the lead frame and the sintered metal layer, a solder layer or the conductive layer described above may be formed between the sintered metal and the lead frame.

Hereinafter, a specific configuration of the electrolytic capacitor according to an exemplary embodiment of the present disclosure will be described with reference to the drawings. However, the electrolytic capacitor according to the present disclosure is not limited to these.

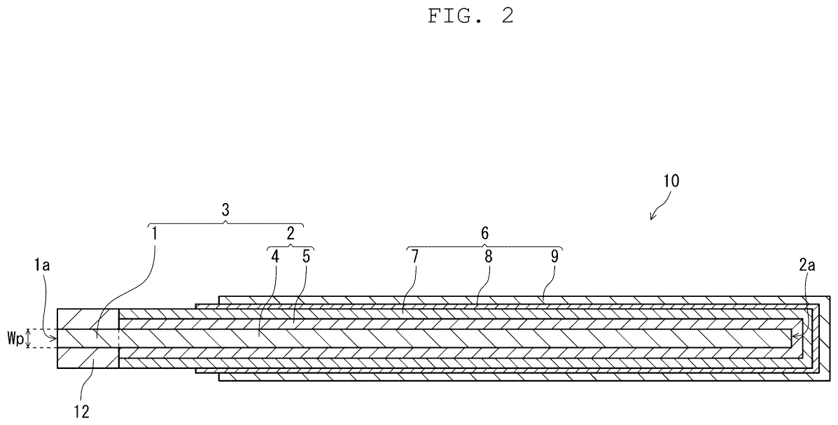

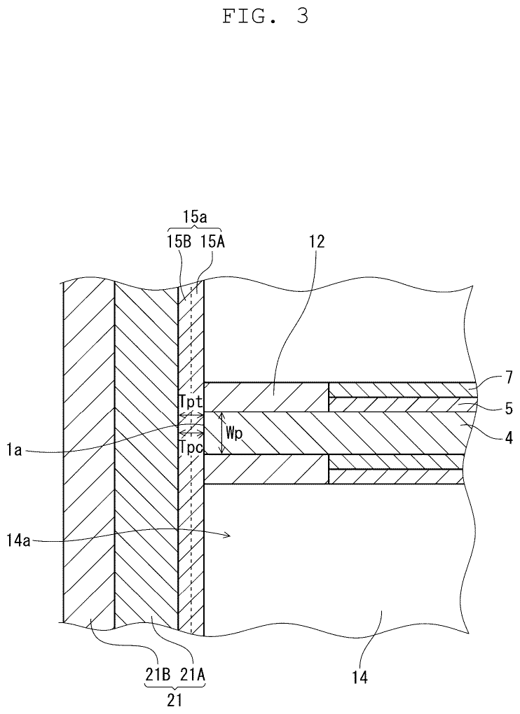

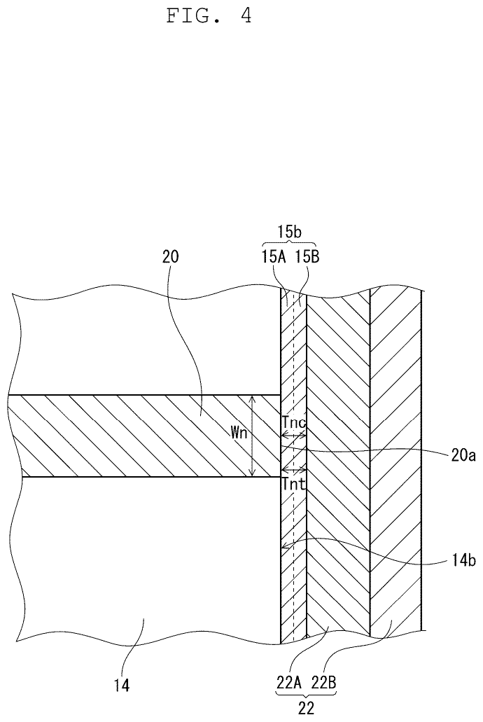

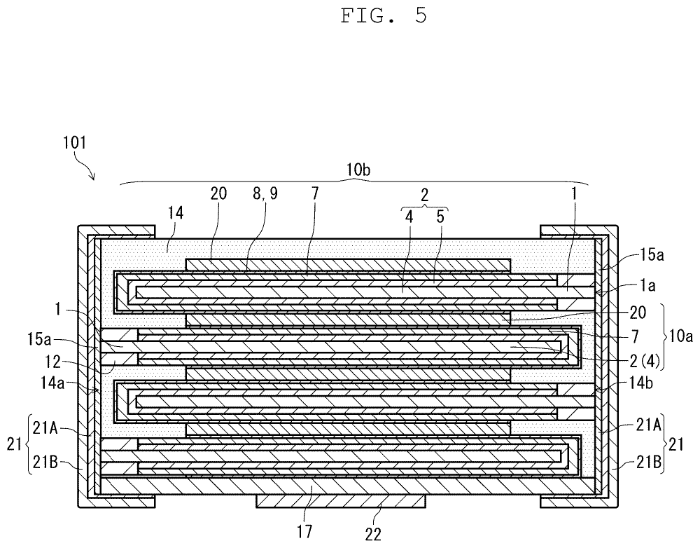

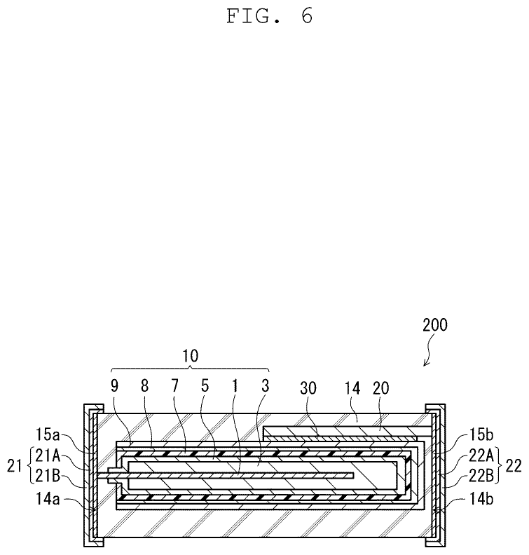

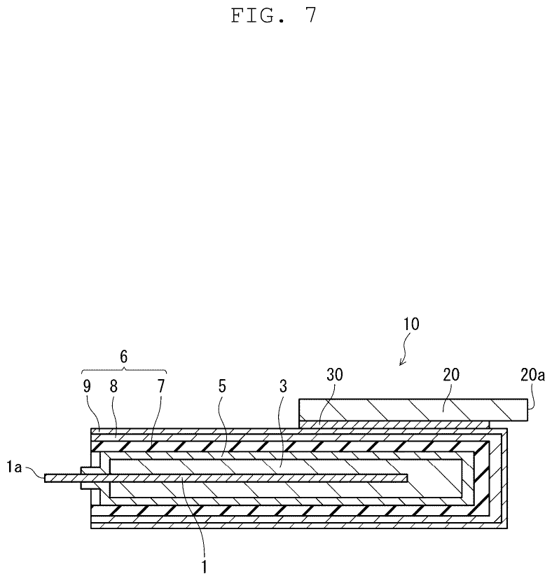

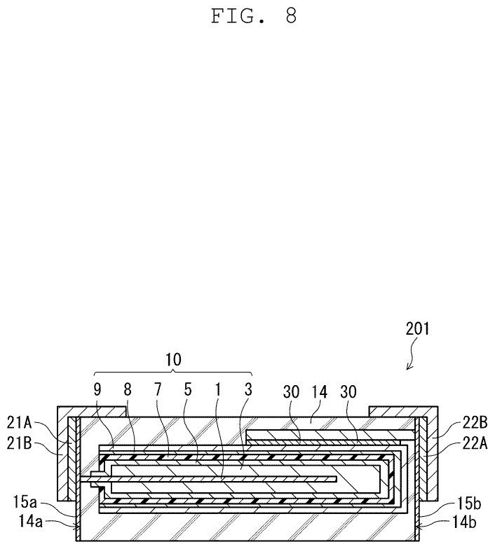

FIG. 1 is a cross-sectional view schematically illustrating the electrolytic capacitor according to one exemplary embodiment. FIG. 2 is a cross-sectional view schematically illustrating a structure of the capacitor element. FIG. 3 is a schematic cross-sectional view illustrating a part of a structure of the electrolytic capacitor illustrated in FIG. 1 in an enlarged manner. FIG. 4 is a schematic cross-sectional view illustrating another part of the structure of the electrolytic capacitor illustrated in FIG. 1 in an enlarged manner. Each of FIGS. 5 and 6 is a cross-sectional view schematically illustrating the electrolytic capacitor according to another exemplary embodiment of the present disclosure. FIG. 7 is a cross-sectional view schematically illustrating a structure of another example of the capacitor element. FIG. 8 is a cross-sectional view schematically illustrating the electrolytic capacitor according to still another exemplary embodiment of the present disclosure.

### FIRST EXEMPLARY EMBODIMENT

As illustrated in FIG. 1, electrolytic capacitor 100 includes a plurality of capacitor elements 10, exterior body 14 that seals capacitor element 10, first external electrode 21, and second external electrode 22. The plurality of capacitor elements 10 are stacked to form an element laminated body.

Capacitor element 10 includes anode body 3 and cathode part 6. Anode body 3 is anode foil. Anode body 3 has metal core portion 4 and porous portion 5, and a dielectric layer (not illustrated) is formed on at least a part of a surface of porous portion 5. Cathode part 6 covers at least a part of the dielectric layer. Cathode part 6 includes a cathode layer and cathode foil 20.

In capacitor element 10, end surface 1a of one end portion (first end portion) is not covered with cathode part 6, and anode body 3 is exposed. On the other hand, end surface 2a of another end portion (second end portion) is covered with cathode part 6. A part that is not covered with the cathode part of anode body 3 is first portion 1. A part covered with the cathode part of anode body 3 is second portion 2. An end portion of first portion 1 is the first end portion. An end portion of second portion 2 is the second end portion. The dielectric layer is formed on a surface of porous portion 5 that is provided at least on second portion 2. First portion 1 of anode body 3 is also referred to as an anode lead-out portion. Second portion 2 of anode body 3 is also referred to a cathode formation portion.

More specifically, second portion 2 includes metal core portion 4 and porous portion 5 formed on a surface of metal core portion 4 by roughening (etching or the like). On the other hand, first portion 1 may or may not have porous portion 5 on a surface. The dielectric layer is provided along a surface of porous portion 5. At least a part of the dielectric layer is formed along an inner wall surface of a hole of porous portion 5 so as to cover the inner wall surface.

The cathode layer includes solid electrolyte layer 7 covering at least a part of the dielectric layer and constituting a part of cathode part 6, and cathode lead-out layers 8, 9 covering at least a part of solid electrolyte layer 7. A surface of the dielectric layer has an uneven shape corresponding to a shape of a surface of anode body 3. Solid electrolyte layer 7 may be formed to fill the unevenness of the dielectric layer. The cathode lead-out layer includes, for example, carbon layer 8 covering at least a part of solid electrolyte layer 7, and conductive paste layer 9 covering carbon layer 8. Conductive paste layer 9 may be, for example, a silver-paste layer containing silver particles as metal particles.

Cathode foil 20 is interposed between cathode lead-out layers 8, 9 of adjacent capacitor elements 10 in a stacking direction of the element laminated body. Cathode foil 20 constitutes a part of cathode part 6. Cathode foil 20 is shared between adjacent capacitor elements 10 in a stacking direction of the element laminated body. An adhesive layer having conductivity may be interposed between cathode foil 20 and capacitor element 10. For the adhesive layer, a conductive adhesive is used, for example. The adhesive layer contains, for example, silver. The adhesive layer may be a silver-paste layer similar to conductive paste layer 9.

It can also be said that a portion of anode body 3 where solid electrolyte layer 7 is formed with the dielectric layer interposed between them is second portion 2, and a portion of anode body 3 where solid electrolyte layer 7 is not formed is first portion 1.

Insulating separation layer (or insulating member) 12 may be formed at least in a portion adjacent to the cathode layer in a region not facing the cathode layer of anode body 3. Separation layer (or insulating member) 12 can be formed so as to cover a surface of anode body 3. By this, contact between cathode part 6 and an exposed part (first portion 1) of anode body 3 is restricted. Separation layer 12 is, for example, an insulating resin layer.

A structure body sealed by exterior body 14 has a substantially rectangular parallelepiped outer shape. Electrolytic capacitor 100 also has a substantially rectangular parallelepiped outer shape. Exterior body 14 has first principal surface 14a and second principal surface 14b on the opposite side of first principal surface 14a. In the element laminated body, first end portion 1a of capacitor element 10 is exposed on first principal surface 14a.

Each of end surfaces 1a of the plurality of first end portions (first portions) exposed from exterior body 14 is electrically connected to first external electrode 21 extending along first principal surface 14a. In this case, a proportion of the first portion to the anode body can be reduced to increase capacitance. Further, contribution of ESR and ESL by the first portion is reduced.

Further, end surface 20a of cathode foil 20 is exposed from exterior body 14 on second principal surface 14b. Each of end surfaces of cathode foil 20 exposed from exterior body 14 is electrically connected to second external electrode 22 extending along second principal surface 14b.

End surfaces 1a of the plurality of first end portions exposed from exterior body 14 and the plurality of end surfaces 20a of cathode foil 20 exposed from exterior body 14 are covered with first sintered metal 15a and second sintered metal 15b, respectively. End surface 1a of the first end portion is electrically connected to first external electrode 21 via sintered metal 15a. End surface 20a of cathode foil 20 is electrically connected to second external electrode 22 via sintered metal 15b.

FIGS. 3 and 4 are schematic cross-sectional views in which a part of a structure of electrolytic capacitor 100 is enlarged. FIG. 3 is an enlarged cross-sectional view of a region near a connecting part between end surface 1a of the first end portion of capacitor element 10 and first external electrode 21 in FIG. 1, and FIG. 4 is an enlarged cross-sectional view of a region near a connecting part between end surface 20a of cathode foil 20 and second external electrode 22. Each of sintered metal 15a and sintered metal 15b includes normal layer 15A and phosphorus-rich layer 15B.

First sintered metal 15a is thin and has a large area, and is bonded to end surface 1a of the first end portion of the anode part by metallic bonding. The ratio Wp/Tpc of width Wp of end surface 1a of the first end portion of the anode part to thickness Tpc of first sintered metal 15a at the center of width Wp satisfies 0.5≤Wp/Tpc≤100. The ratio Tpc/Tpt of thickness Tpc of first sintered metal 15a at the center of width Wp to thickness Tpt at a position away from the center by Wp/3 is more than or equal to 0.5 (approximately 1.0 in the illustrated example).

Contact area Spo between first sintered metal 15a and first external electrode 21 is substantially equal to width of first principal surface 14a in the reference cross section. Contact area Spi between first sintered metal 15a and end surface 1a of the first end portion of the anode part is approximately equal to the product of Wp and the number of laminated capacitor elements. The ratio Spo/Spi of Spo to Spi is sufficiently larger than 1.0, and is at least 3 or more in the illustrated example.

Second sintered metal 15b is thin and has a large area, and is bonded to end surface 20a of cathode foil 20 by metallic bonding. The ratio Wn/Tnc of width Wn of end surface 20a of cathode foil 20 to thickness Tnc of second sintered metal 15b at the center of width Wn satisfies 0.5≤Wn/Tnc≤100. The ratio Tnc/Tnt of thickness Tnc of first sintered metal 15b at the center of width Wn to thickness Tnt at a position Wn/3 away from the center is more than or equal to 0.5 (approximately 1.0 in the illustrated example).

Contact area Sno between second sintered metal 15b and second external electrode 22 is substantially equal to width of second principal surface 14b in the reference cross section. Contact area Sni between second sintered metal 15b and end surface 20a of cathode foil 20 is approximately equal to the product of Wn and the number of laminated capacitor elements. The ratio Sno/Sni of Sno to Sni is sufficiently larger than 1.0, and is at least 3 or more in the illustrated example.

As illustrated in FIG. 3, normal layer 15A covers an end surface of first end portion 1a. Phosphorus-rich layer 15B covers normal layer 15A in a state of being integrated with normal layer 15A. In FIG. 3, phosphorus-rich layer 15B is covered with first external electrode 21. Similarly, as illustrated in FIG. 4, normal layer 15A covers an end surface of cathode foil 20. Phosphorus-rich layer 15B usually covers normal layer 15A. In FIG. 4, phosphorus-rich layer 15B is covered with second external electrode 22. By forming normal layer 15A and phosphorus-rich layer 15B as sintered metals 15a and 15b as the base metal, a current collecting path excellent in corrosion resistance can be formed, and deterioration of the cathode layer is suppressed.

First external electrode 21 includes, for example, silver-paste layer 21A and a Ni/Sn plating layer 21B. Silver-paste layer 21A covers sintered metal 15a covering an end surface of first end portion 1a and first principal surface 14a (first surface) of exterior body 14. Ni/Sn plating layer 21B covers silver-paste layer 21A. Second external electrode 22 includes silver-paste layer 22A and Ni/Sn plating layer 22B. Silver-paste layer 22A covers sintered metal layer 15 covering an end surface of cathode foil 20 and second principal surface 14b (second surface) of exterior body 14. Ni/Sn plating layer 22B covers silver-paste layer 22A.

In FIG. 1, an end surface of first end portion 1a is flush with first principal surface 14a. Further, in FIG. 1, end surface 20a of cathode foil 20 is flush with second principal surface 14b. However, the end surface of first end portion 1a and end surface 20a of cathode foil 20 are not necessarily flush with a principal surface of exterior body 14. For example, the end surface of first end portion 1a may protrude or be recessed with respect to first principal surface 14a. Similarly, end surface 20a of cathode foil 20 may protrude or be recessed with respect to second principal surface 14b.

Sintered metal 15a may cover an end surface of separation layer 12 exposed from first principal surface 14a. Further, in a case where porous layer 5 extends to first principal surface 14a, sintered metal 15a may be formed so as to cover porous layer 5 exposed from first principal surface 14a.

The element laminated body is supported by substrate 17. The substrate may be, for example, an insulating substrate. The substrate may be a metal substrate or a printed substrate provided with a wiring pattern as long as first external electrodes 21 and second external electrode 22 can be electrically separated from each other. The cathode foil may be arranged between the cathode lead-out layer located on a lowermost surface of the element laminated body and substrate 17. Substrate 17 may be, for example, a laminated substrate in which a conductive wiring pattern is formed on its front surface and back surface. In this case, the wiring pattern on the front surface of the substrate and the wiring pattern on the back surface may be electrically connected by a through hole. The wiring pattern on the front surface can be electrically connected to cathode part 6 of the capacitor element laminated on a lowermost layer. Further, the wiring pattern on the back surface can be electrically connected to a third external electrode (not illustrated). In this case, the third external electrode is electrically connected to cathode part 6 of each capacitor element of the element laminated body via substrate 17. The third external electrode (cathode) can be optionally arranged in a central region of a bottom surface of the electrolytic capacitor depending on the wiring pattern on the back surface. For example, ESL can be reduced by arranging the third external electrode close to the first external electrode.

Substrate 17 is a metal plate, and may have a lead frame structure in which a metal plate processed into a predetermined shape is bent. A part of the metal plate is exposed from the exterior body, and is electrically connected to an external terminal at an exposed portion.

### SECOND EXEMPLARY EMBODIMENT

FIG. 5 is a cross-sectional view schematically illustrating a structure of the electrolytic capacitor according to another exemplary embodiment of the present disclosure. Electrolytic capacitor 101 illustrated in FIG. 5 includes a plurality of capacitor elements 10a, 10b, exterior body 14 that seals capacitor elements 10a, 10b, first external electrode 21, and second external electrode 22. The plurality of capacitor elements 10a, 10b are stacked to form an element laminated body. The two first external electrodes 21 are disposed apart from each other, one first external electrode 21 covers first principal surface 14a of exterior body 14, and another first external electrode 21 covers second principal surface 14b of exterior body 14.

The plurality of capacitor elements 10a, 10b include first capacitor element 10a in which a direction from first portion 1 toward second portion 2 of anode body 3 is a first direction, and second capacitor element 10b in which a direction from first portion 1 toward second portion 2 of anode body 3 is a second direction opposite to the first direction. End surface 1a of the first end portion of first capacitor element 10a is exposed from exterior body 14 on first principal surface 14a, and is electrically connected to one first external electrode 21 via sintered metal 15a. End surface 1a of the first end portion of second capacitor element 10b is exposed from exterior body 14 on second principal surface 14b, and is electrically connected to another first external electrode 21 via sintered metal 15a. On the other hand, although not illustrated, in a third principal surface intersecting first principal surface 14a and second principal surface 14b and/or a fourth principal surface opposite to the third principal surface, an end surface of cathode foil 20 is exposed from exterior body 14, and is electrically connected to second external electrode 22 via sintered metal 15.

Sintered metal 15a has a similar configuration to sintered metal 15a of electrolytic capacitor 100 illustrated in FIG. 1. First external electrode 21 has a similar configuration to first external electrode 21 of electrolytic capacitor 100 illustrated in FIG. 1.

In electrolytic capacitor 101, first capacitor element 10a and second capacitor element 10b are different from each other in a direction in which current flows in the elements. For this reason, since a direction of a magnetic field generated by current is different, magnetic flux generated in the element laminated body decreases. By this, ESL can be reduced.

In the example of FIG. 5, in the element laminated body, first capacitor element 10a and second capacitor element 10b are alternately stacked. However, first capacitor element 10a and second capacitor element 10b do not need to be alternately stacked. In a part of the element laminated body, there may be a portion where first capacitor elements 10a are adjacent to each other and stacked in the same direction and/or a portion where second capacitor elements 10b are adjacent to each other and stacked in the same direction. Since magnetic flux generated in the element laminated body is effectively reduced and ESL is effectively reduced, the first capacitor elements and the second capacitor elements are preferably alternately stacked even partially.

### THIRD EXEMPLARY EMBODIMENT

FIG. 6 is a cross-sectional view schematically illustrating a structure of the electrolytic capacitor according to still another exemplary embodiment of the present disclosure. Electrolytic capacitor 200 according to the present exemplary embodiment includes a capacitor element as illustrated in FIG. 7. Capacitor element 10 includes anode body 3 that is a sintered body of metal particles, and metal wire 1 partially embedded in anode body 3. Metal wire 1 corresponds to the first portion, and the sintered body corresponds to the second portion. Therefore, an end surface of the anode part is end surface 1a of a terminal end portion of metal wire 1. Dielectric layer 5 is formed on at least a part of a surface of anode body 3. Cathode part 6 covers at least a part of dielectric layer 5. Cathode part 6 includes solid electrolyte layer 7, a cathode lead-out layer, and cathode foil 20.

Anode body 3 can be obtained by molding and sintering powder containing valve metal. For example, together with powder of valve metal, an embedded portion of metal wire 1 to be connected to anode body 3 is placed in a mold in a manner embedded in the powder, and molded by pressurization. After the above, the molded body is sintered to form porous anode body 3 in which a part of metal wire 1 is embedded. The sintering is preferably performed under reduced pressure. Sintered body is subjected to anodizing treatment to form dielectric layer 5 on a surface of the sintered body.

The cathode lead-out layer includes, for example, carbon layer 8 covering at least a part of solid electrolyte layer 7, and conductive paste layer 9 covering carbon layer 8. Conductive paste layer 9 may be, for example, a silver-paste layer containing silver particles as metal particles. Carbon layer 8 is formed of a composition including a conductive carbon material such as graphite.

Cathode foil 20 constitutes a part of cathode part 6. Cathode foil 20 is connected to the cathode layer by a conductive adhesive layer. For the adhesive layer, a conductive adhesive is used, for example. The adhesive layer contains, for example, silver. The adhesive layer may be a silver-paste layer similar to conductive paste layer 9.

Anode body 3 has a substantially rectangular parallelepiped outer shape. Electrolytic capacitor 200 also has a substantially rectangular parallelepiped outer shape. Exterior body 14 has first principal surface 14a and second principal surface 14b on the opposite side of first principal surface 14a. End surface 1a of a terminal end portion of the metal wire of capacitor element 10 is exposed on first principal surface 14a. End surface 1a exposed from exterior body 14 is electrically connected to first external electrode 21 extending along first principal surface 14a. Further, end surface 20a of cathode foil 20 is exposed from the exterior body 14 on second principal surface 14b. End surface 20a of cathode foil 20 exposed from exterior body 14 is electrically connected to second external electrode 22 extending along second principal surface 14b. In this case, length of the metal wire occupying the anode part can be reduced to increase capacitance. Further, contribution of ESR and ESL by the metal wire is reduced.

End surface 1a of the terminal end portion of the metal wire exposed from exterior body 14 and end surface 20a of cathode foil 20 exposed from exterior body 14 are covered with first and second sintered metals 15a and 15b, respectively. End surface 1a of the terminal end portion of the metal wire is electrically connected to first external electrode 21 via sintered metal 15a. End surface 20a of cathode foil 20 is electrically connected to second external electrode 22 via sintered metal 15b.

First and second sintered metals 15a and 15b have a similar configuration to first and second sintered metals 15a and 15b of electrolytic capacitor 100 illustrated in FIG. 1. First external electrode 21 and second external electrode 22 have a similar configuration as first external electrode 21 and second external electrode 22 of electrolytic capacitor 100 illustrated in FIG. 1.

### FOURTH EXEMPLARY EMBODIMENT

FIG. 8 is a cross-sectional view schematically illustrating a structure of the electrolytic capacitor according to still another exemplary embodiment of the present disclosure. Electrolytic capacitor 201 according to the present exemplary embodiment has a similar configuration to electrolytic capacitor 200 according to the third exemplary embodiment except that a configuration of first external electrode 21 and second external electrode 22 is different.

First external electrode 21 and second external electrode 22 of electrolytic capacitor 201 include first lead frame 21B and a second lead frame 22B that cover at least a part of first sintered metal 15a and at least a part of second sintered metal 15b, respectively. Solder layer 21A (conductive layer 21A) is formed between first sintered metal 15a and first lead frame 21B. Similarly, solder layer 22A (conductive layer 22A) is formed between second sintered metal 15a and second lead frame 22B. By this, strong electrical connection between first lead frame 21B and first sintered metal 15a and strong electrical connection between second lead frame 22B and second sintered metal 15b can be formed.

### APPENDIX

The above description of the exemplary embodiment discloses a technique below.

### (Technique 1)

An electrolytic capacitor includes:
a capacitor element including an anode part and a cathode part;
an exterior body that seals the capacitor element;
a first external electrode electrically connected to the anode part and exposed from the exterior body;
a second external electrode electrically connected to the cathode part and exposed from the exterior body; and
a first base electrode that connects the anode part and the first external electrode.

The first base electrode contains a first sintered metal,
the first sintered metal is in contact with an end surface of the anode part and is in contact with the first external electrode, the end surface of the anode part being not covered with the exterior body, and
a following relation is satisfied:

$$0.5 \leq Wp / Tpc \leq 100$$

where Wp represents a width of the end surface of the anode part, and Tpc represents a thickness of the first sintered metal at a center of the width Wp.

It is noted that, 1.5≤Wp/Tpc≤100 is preferably satisfied, and 2≤Wp/Tpc≤100 is more preferably satisfied.

### (Technique 2)

The electrolytic capacitor according to Technique 1, in which a following relation is satisfied:

$$0.5 \leq Tpc / Tpt$$

where Tpc represents a thickness of the first sintered metal at a center of the width Wp, and Tpt represents a thickness of the first sintered metal at a position away from the center by Wp/3

It is noted that 0.5≤Tpc/Tpt≤2 is preferably satisfied.

### (Technique 3)

The electrolytic capacitor according to Technique 1 or 2, in which a following relation is satisfied:

$$1. \leq Spo / Spi$$

where Spo represents a contact area between the first sintered metal and the first external electrode, and Spi represents a contact area between the first sintered metal and the end surface of the anode part.

It is noted that 3≤Spo/Spi is preferably satisfied.

### (Technique 4)

The electrolytic capacitor according to any one of Techniques 1 to 3, in which the first sintered metal further covers a first surface of the exterior body facing the first external electrode.

### (Technique 5)

The electrolytic capacitor according to any one of Techniques 1 to 4, in which
the first sintered metal contains the phosphorus element, and
the phosphorus element is distributed more in a region close to the first external electrode than in a region close to the end surface of the anode part.

### (Technique 6)

The electrolytic capacitor according to any one of Techniques 1 to 5, in which the first external electrode includes a plating layer that covers at least a part of the first sintered metal.

### (Technique 7)

The electrolytic capacitor according to any one of Techniques 1 to 6, in which
the first external electrode further includes a conductive layer disposed between the first sintered metal and the plating layer, and
the conductive layer includes a metal particle and resin.

### (Technique 8)

The electrolytic capacitor according to any one of Techniques 1 to 7, in which the first external electrode includes a lead frame that covers at least a part of the first sintered metal.

### (Technique 9)

The electrolytic capacitor according to any one of Techniques 1 to 8, in which the first external electrode further includes a solder layer disposed between the first sintered metal and the lead frame.

### (Technique 10)

The electrolytic capacitor according to any one of Techniques 1 to 9, in which the capacitor element includes:
an anode body having a first portion that includes a first end portion of the anode body and a second portion that includes a second end portion of the anode body;
a dielectric layer disposed on a surface of the second portion of the anode body; and
a cathode layer covering at least a part of the dielectric layer,
the anode part includes the first portion of the anode body,
the cathode part includes the cathode layer, and
the first sintered metal is in contact with an end surface of the first end portion.

### (Technique 11)

The electrolytic capacitor according to any one of Techniques 1 to 10, in which
the anode body includes an anode foil,
the anode foil includes a metal core portion and a porous portion continuous with the metal core portion, and
the end surface of the first end portion includes an end surface of the metal core portion and an end surface of the porous portion.

### (Technique 12)

The electrolytic capacitor according to any one of Techniques 1 to 11, in which
the anode body includes a metal wire and a sintered body of metal particles, the metal wire being partially embedded in the sintered body, and
the end surface of the first end portion includes an end surface of a terminal end portion of the metal wire.

### (Technique 13)

The electrolytic capacitor according to any one of Techniques 1 to 12, further including a second base electrode that connects the cathode part and the second external electrode, in which:
the second base electrode contains a second sintered metal,
the second sintered metal is in contact with an end surface of the cathode part and is in contact with the second external electrode, the end surface of the cathode part being not covered with the exterior body, and
a following relation is satisfied:

$$0.5 \leq Wn / Tnc \leq 100$$

where Wn represents a width of the end surface of the cathode part, and Tnc represents a thickness of the second sintered metal at a center of the width Wn.

It is noted that 1.5≤Wn/Tnc≤100 is preferably satisfied, and 2≤Wn/Tnc≤100 is more preferably satisfied.

### (Technique 14)

The electrolytic capacitor according to Technique 13, in which a following relation is satisfied:

$$0.5 \leq Tnc / Tnt$$

where Tnc represents a thickness of the second sintered metal at a center of the width Wn, and Tnt represents a thickness of the second sintered metal at a position away from the center by Wn/3.

### (Technique 15)

The electrolytic capacitor according to Technique 13 or 14, in which a following relation is satisfied:

$$1. \leq Sno / Sni$$

where Sno represents a contact area between the second sintered metal and the second external electrode, and Sni represents a contact area between the second sintered metal and the end surface of the cathode part.

### (Technique 16)

The electrolytic capacitor according to any one of Techniques 13 to 15, in which the second sintered metal further covers a second surface of the exterior body facing the second external electrode.

### (Technique 17)

The electrolytic capacitor according to any one of Techniques 13 to 16, in which:
the cathode part further includes cathode foil that is connected to the cathode layer and protrudes further than the cathode layer, and
the second sintered metal is in contact with an end surface of a terminal end portion of the cathode foil.

### (Technique 18)

A production method for an electrolytic capacitor, the production method including:
a step of preparing a capacitor element including an anode part and a cathode part;
a step of sealing the capacitor element with an exterior body;
a step of exposing an end surface of the anode part from the exterior body;
a step of forming a first base electrode on the end surface of the anode part; and
a step of forming a first external electrode electrically connected to the anode part via the first base electrode, in which:
the step of forming the first base electrode includes:
(i) a step of attaching a metal nanoink containing metal nanoparticles to the end surface of the anode part and a first surface of the exterior body, the first surface of the exterior body facing the first external electrode; and
(ii) a step of forming a first sintered metal by irradiating the metal nanoparticles with a light to sinter the metal nanoparticles after the step (i).

### (Technique 19)

The production method for an electrolytic capacitor according to Technique 18, in which:
the step (ii) of forming the first sintered metal includes:
a step of forming a part of the first sintered metal by irradiating the metal nanoparticles located on the first surface of the exterior body with a first light to sinter the metal nanoparticles located on the first surface of the exterior body; and
a step of forming a remaining part of the first sintered metal by irradiating the metal nanoparticles located on the end surface of the anode part with a second light having higher energy than the first light to sinter the metal nanoparticles located on the end surface of the anode part.

### (Technique 20)

The production method for an electrolytic capacitor according to Technique 18 or 19, in which the metal nanoink contains a phosphoric ester.

### (Technique 21)

The production method for an electrolytic capacitor according to any one of Techniques 18 to 20, in which the metal nanoink further contains a reducing agent.

### (Technique 22)

The production method for an electrolytic capacitor according to any one of Techniques 18 to 21, in which the reducing agent contains an organic acid.

### (Technique 23)

The production method for an electrolytic capacitor according to any one of Techniques 18 to 22, in which the organic acid includes at least one of adipic acid or abietic acid.

### (Technique 24)

The production method for an electrolytic capacitor according to any one of Techniques 21 to 23, in which a ratio of mass of the reducing agent to mass of the metal nanoparticles in the metal nanoink ranges from 5 wt % to 20 wt %, inclusive.

### (Technique 25)

The production method for an electrolytic capacitor according to any one of Techniques 18 to 24, in which in the step (ii) of forming the first sintered metal, the metal nanoparticles are irradiated with a light from a xenon light source or a light from YAG laser.

### (Technique 26)

The production method for an electrolytic capacitor according to any one of Techniques 18 to 25, further including:
a step of exposing an end surface of the cathode part from the exterior body;
a step of forming a second base electrode on the end surface of the cathode part; and
a step of forming a second external electrode electrically connected to the cathode part via the second base electrode, in which:
the step of forming the second base electrode includes:
(iii) a step of attaching a metal nanoink containing metal nanoparticles to an end surface of the cathode part and a second surface of the exterior body, the second surface of the exterior body facing the second external electrode; and
(iv) a step of forming a second sintered metal by irradiating the metal nanoparticles with a light to sinter the metal nanoparticles after the step (iii).

### (Technique 27)

The production method for an electrolytic capacitor according to Technique 26, in which
the step (iv) of forming the second sintered metal includes:
a step of forming a part of the second sintered metal by irradiating the metal nanoparticles located on the second surface of the exterior body with a first light to sinter the metal nanoparticles located on the second surface of the exterior body; and
a step of forming a remaining part of the second sintered metal by irradiating the metal nanoparticles located on the end surface of the cathode part with a second light having higher energy than the first light to sinter the metal nanoparticles located on the end surface of the cathode part.

### EXAMPLE

In order to produce an electrolytic capacitor similar to electrolytic capacitor 100 as illustrated in FIG. 1, a plurality of capacitor elements were prepared. As the anode body, anode foil made from aluminum having a porous portion formed by etching was used. Seven capacitor elements were stacked with a cathode foil made from aluminum foil having carbon coating interposed between them to obtain an element laminated body. The cathode foil was disposed such that a part of the cathode foil protruded from the cathode layer toward the opposite side of the anode part. After the above, the entire element laminated body was sealed with an exterior body. Next, a part on the first end portion side of the first portion of the anode body and the exterior body were simultaneously removed by cutting to expose an end surface of the anode part. Similarly, a protrusion of the cathode foil and the exterior body were simultaneously removed by cutting to expose an end surface of the cathode part.

Next, copper nanoink was applied to each of the end surface of the anode part and the end surface of the cathode part. The applied copper nanoink was dried at 80° C. for one minute, and then irradiated with pulse light (pulse width 0.99 ms) of xenon flash light (wavelength 250 nm to 800 nm) to sinter copper nanoparticles, so as to form sintered metal (sintered copper layer) having thickness of 1.5 μm.

The composition of the copper nanoink is as described below.
copper nanoparticles (average particle size: 65 nm): 100 parts by mass
Dispersant (phosphoric ester (ethyl acid phosphate)): 8 parts by mass
Reducing agent (adipic acid): 5 parts by mass
Reducing agent (abietic acid): 5 parts by mass

Organic solvent (2-methyl-2,4-pentanediol): 25 parts by mass

Subsequently, the sintered metal was covered with silver paste and dried to form a conductive layer (silver-paste layer) having thickness of 20 μm. Furthermore, a Ni plating layer (thickness: 5 μm) and a Sn plating layer (thickness: 5 μm) were sequentially formed on a surface of the conductive layer by a barrel plating method to form the first external electrode and the second external electrode. A total of three electrolytic capacitors were produced, and electrostatic capacitance was evaluated. As a result, while a target value was 470 μF, 530 μF, 526 μF, and 529 μF were obtained, and it was confirmed that the target was achieved.

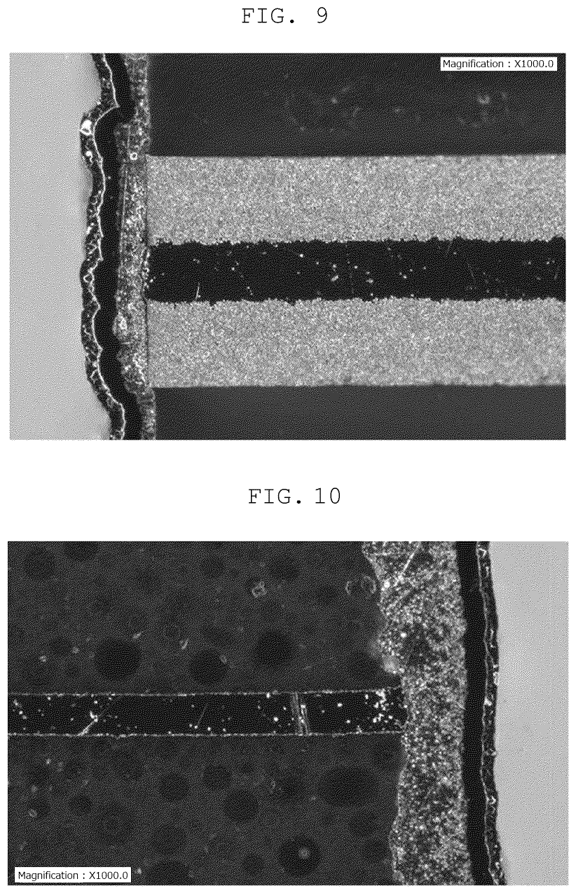

Next, the anode part or the cathode part, and a laminated part (reference cross section) of the sintered metal and the silver-paste layer were observed with a digital microscope (VHX-8000) manufactured by KEYENCE CORPORATION. An example of a shot image is illustrated in FIG. 9 (anode side) and FIG. 10 (cathode side). Three layers of the Sn plating layer, the Ni plating layer, and the conductive layer (silver-paste layer) can be clearly confirmed from the outside. Further, a thin layer of sintered metal having metallic luster more than each of other layers can be confirmed at an interface between an end surface of each of the anode part and the cathode part and the conductive layer (silver-paste layer).

The ratio Wp/Tpc of width Wp (115 μm) of an end surface of the anode part to thickness Tpc of the first sintered metal at the center of width Wp was 77. The ratio Tpc/Tpt of thickness Tpc of the first sintered metal at the center of width Wp to thickness Tpt at a position away from the center by Wp/3 was in a range of 1.0 to 1.1. The ratio Spo/Spi of contact area Spo between the first sintered metal and the first external electrode to contact area Spi between the first sintered metal and an end surface of the anode part was sufficiently larger than 3. Further, in any of the electrolytic capacitors, no peeling was observed between the first sintered metal and the silver-paste layer.

The ratio Wn/Tnc of width Wn (20 μm) of an end surface of the cathode part to thickness Tnc of the second sintered metal at the center of width Wn was 6.7. The ratio Tnc/Tnt of thickness Tnc of the second sintered metal at the center of width Wn to thickness Tnt at a position away from the center by Wn/3 was about 1.2. The ratio Sno/Sni of contact area Sno between the second sintered metal and the second external electrode to contact area Sni between the second sintered metal and an end surface of the cathode part was larger than 1.0 and sufficiently larger than 3. Further, in any of the electrolytic capacitors, no peeling was observed between the second sintered metal and the silver-paste layer.

Furthermore, when a distribution state of the phosphorus element in each sintered metal was analyzed, the phosphorus element was distributed over the entire sintered metal. The phosphorus element was more distributed on the external electrode side than on the end surface side of the anode part or the cathode part, and it could be observed that a phosphorus-rich layer was formed.

The electrolytic capacitor according to the present invention can be efficiently manufactured at low cost, and can be used for various applications because deterioration of the cathode part due to moisture or oxygen hardly occurs.

Although the present invention is described in terms of the preferred exemplary embodiment at present, such disclosure should not be construed in a limiting manner. Various variations and modifications will become clear to those skilled in the art to which the present invention pertains upon reading the above disclosure. Thus, the appended claims should be construed to cover all variations and modifications without departing from the true spirit and scope of the present invention.

What is claimed is:

1. An electrolytic capacitor comprising:
a capacitor element including an anode part and a cathode part;
an exterior body that seals the capacitor element;
a first external electrode electrically connected to the anode part and exposed from the exterior body;
a second external electrode electrically connected to the cathode part and exposed from the exterior body; and
a first base electrode that connects the anode part and the first external electrode, wherein:
the first base electrode contains a first sintered metal,
the first sintered metal is in contact with an end surface of the anode part and is in contact with the first external electrode, the end surface of the anode part being not covered with the exterior body, and
a following relation is satisfied:
$$0.5 \leq Wp / Tpc \leq 100$$
where Wp represents a width of the end surface of the anode part, and Tpc represents a thickness of the first sintered metal at a center of the width Wp.

2. The electrolytic capacitor according to claim 1, wherein a following relation is satisfied:
$$0.5 \leq Tpc / Tpt$$
where Tpc represents a thickness of the first sintered metal at a center of the width Wp, and Tpt represents a thickness of the first sintered metal at a position away from the center by Wp/3.

3. The electrolytic capacitor according to claim 1, wherein a following relation is satisfied:
$$1. \leq Spo / Spi$$
where Spo represents a contact area between the first sintered metal and the first external electrode, and Spi represents a contact area between the first sintered metal and the end surface of the anode part.

4. The electrolytic capacitor according to claim 1, wherein the first sintered metal further covers a first surface of the exterior body facing the first external electrode.

5. The electrolytic capacitor according to claim 1, wherein:
the first sintered metal contains a phosphorus element, and
the phosphorus element is distributed more in a region close to the first external electrode than in a region close to the end surface of the anode part.

6. The electrolytic capacitor according to claim 1, wherein the first external electrode includes a plating layer that covers at least a part of the first sintered metal.

7. The electrolytic capacitor according to claim 6, wherein:
the first external electrode further includes a conductive layer disposed between the first sintered metal and the plating layer, and
the conductive layer includes a metal particle and resin.

8. The electrolytic capacitor according to claim 1, wherein the first external electrode includes a lead frame that covers at least a part of the first sintered metal.

9. The electrolytic capacitor according to claim 8, wherein the first external electrode further includes a solder layer disposed between the first sintered metal and the lead frame.

10. The electrolytic capacitor according to claim 1, wherein:
the capacitor element includes:
an anode body having a first portion that includes a first end portion of the anode body and a second portion that includes a second end portion of the anode body;
a dielectric layer disposed on a surface of the second portion of the anode body; and
a cathode layer covering at least a part of the dielectric layer,
the anode part includes the first portion of the anode body,
the cathode part includes the cathode layer, and
the first sintered metal is in contact with an end surface of the first end portion.

11. The electrolytic capacitor according to claim 10, wherein:
the anode body includes an anode foil,
the anode foil includes a metal core portion and a porous portion continuous with the metal core portion, and
the end surface of the first end portion includes an end surface of the metal core portion and an end surface of the porous portion.

12. The electrolytic capacitor according to claim 10, wherein:
the anode body includes a metal wire and a sintered body of metal particles, the metal wire being partially embedded in the sintered body, and
the end surface of the first end portion includes an end surface of a terminal end portion of the metal wire.

13. The electrolytic capacitor according to claim 1, further comprising a second base electrode that connects the cathode part and the second external electrode, wherein:
the second base electrode contains a second sintered metal,
the second sintered metal is in contact with an end surface of the cathode part and is in contact with the second external electrode, the end surface of the cathode part being not covered with the exterior body, and
a following relation is satisfied:
$$0.5 \leq Wn / Tnc \leq 100$$
where Wn represents a width of the end surface of the cathode part, and Tnc represents a thickness of the second sintered metal at a center of the width Wn.

14. The electrolytic capacitor according to claim 13, wherein a following relation is satisfied:
$$0.5 \leq Tnc / Tnt$$
where Tnc represents a thickness of the second sintered metal at a center of the width Wn, and Tnt represents a thickness of the second sintered metal at a position away from the center by Wn/3.

15. The electrolytic capacitor according to claim 13, wherein a following relation is satisfied:
$$1. \leq Sno / Sni$$
where Sno represents a contact area between the second sintered metal and the second external electrode, and Sni represents a contact area between the second sintered metal and the end surface of the cathode part.

16. The electrolytic capacitor according to claim 13, wherein the second sintered metal further covers a second surface of the exterior body facing the second external electrode.

17. The electrolytic capacitor according to claim 13, wherein:
the cathode part further includes cathode foil that is connected to the cathode layer and protrudes further than the cathode layer, and
the second sintered metal is in contact with an end surface of a terminal end portion of the cathode foil.

18. A production method for an electrolytic capacitor, the production method comprising:
a step of preparing a capacitor element including an anode part and a cathode part;
a step of sealing the capacitor element with an exterior body;
a step of exposing an end surface of the anode part from the exterior body;
a step of forming a first base electrode on the end surface of the anode part; and
a step of forming a first external electrode electrically connected to the anode part via the first base electrode, wherein
the step of forming the first base electrode includes:
(i) a step of attaching a metal nanoink containing metal nanoparticles to the end surface of the anode part and a first surface of the exterior body, the first surface of the exterior body facing the first external electrode; and
(ii) a step of forming a first sintered metal by irradiating the metal nanoparticles with a light to sinter the metal nanoparticles after the step (i).

19. The method according to claim 18, wherein
the step (ii) of forming the first sintered metal includes:
a step of forming a part of the first sintered metal by irradiating the metal nanoparticles located on the first surface of the exterior body with a first light to sinter the metal nanoparticles located on the first surface of the exterior body; and
a step of forming a remaining part of the first sintered metal by irradiating the metal nanoparticles located on the end surface of the anode part with a second light having higher energy than the first light to sinter the metal nanoparticles located on the end surface of the anode part.

20. The method according to claim 18, wherein the metal nanoink contains a phosphoric ester.

21. The method according to claim 18, wherein the metal nanoink further contains a reducing agent.

22. The method according to claim 21, wherein the reducing agent contains an organic acid.

23. The method according to claim 22, wherein the organic acid includes at least one of adipic acid or abietic acid.

24. The method according to claim 21, wherein a ratio of a mass of the reducing agent to a mass of the metal nanoparticles in the metal nanoink ranges from 5 wt % to 20 wt %, inclusive.

25. The method according to claim 18, wherein in the step (ii) of forming the first sintered metal, the metal nanoparticles are irradiated with a light from a xenon light source or a light from YAG laser.

26. The method according to claim 18, further comprising:
a step of exposing an end surface of the cathode part from the exterior body;
a step of forming a second base electrode on the end surface of the cathode part; and
a step of forming a second external electrode electrically connected to the cathode part via the second base electrode, wherein
the step of forming the second base electrode includes:
(iii) a step of attaching a metal nanoink containing metal nanoparticles to an end surface of the cathode part and a second surface of the exterior body, the second surface of the exterior body facing the second external electrode; and
(iv) a step of forming a second sintered metal by irradiating the metal nanoparticles with a light to sinter the metal nanoparticles after the step (iii).

27. The method according to claim 26, wherein
the step (iv) of forming the second sintered metal includes:
a step of forming a part of the second sintered metal by irradiating the metal nanoparticles located on the second surface of the exterior body with a first light to sinter the metal nanoparticles located on the second surface of the exterior body; and
a step of forming a remaining part of the second sintered metal by irradiating the metal nanoparticles located on the end surface of the cathode part with a second light having higher energy than the first light to sinter the metal nanoparticles located on the end surface of the cathode part.
